(19) United States
(12) Patent Application Publication
(10) Pub. No.: US 2008/0201881 A1
(43) Pub. Date: Aug. 28, 2008

(54) PET CHEW TOY BRUSH

(75) Inventors: Steven B. Dunn, Beverly Hills, CA (US); Mark Hatherill, Beverly Hills, CA (US); Thomas Birkert, West Hills, CA (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(73) Assignee: MUNCHKIN, INC., North Hills, CA (US)

(21) Appl. No.: 11/677,952

(22) Filed: Feb. 22, 2007

(51) Int. Cl. A46B 1/00; A01K 29/00

(52) U.S. Cl. 15/106; 119/710

(57) ABSTRACT

A system for cleaning a pet chew toy of the type that has a sidewall having an inner surface defining a hollow interior and at least one opening defined in the sidewall communicating with the hollow interior includes a first brush having a stem portion and a plurality of bristles. The stem portion and the bristles are both constructed and arranged so as to be able to fit through an opening in the sidewall of the pet chew toy. The bristles are further dimensioned so as to facilitate scrubbing of the inner surface of the sidewall of the pet chew toy. A handle is operatively connected to the stem portion of the first brush, and a second brush is provided that is constructed and arranged so as to be able to fit through a second opening in the sidewall of the pet chew toy. A method of cleaning a pet chew toy is also disclosed.

### BACKGROUND OF THE INVENTION

1. Field of the Invention

This invention relates generally to the pet industry and pet products, and more specifically to a system for maintaining pet chew toys in good hygienic condition.

2. Description of the Related Technology

Many types of pets, particularly dogs, are instinctually predisposed to chewing on small objects. Dogs evolved from wolves and by nature are predatory carnivores. Chewing on bones is behavior that evolved from the fact that important nutritional benefit is to be gained by carnivores by cracking open the bones of their prey with their teeth in order to be able to eat the bone marrow. Chewing exercises dogs jaw muscles and keeps their teeth and gums clean. It is normal, healthy behavior for dogs, and dog owners typically use a wide assortment of toys and treats to indulge this behavior.

One type of dog chew toy that is particularly popular is made of a resilient material and has a hollow interior that is defined by a contoured sidewall. One or more holes are defined in the sidewall that permits the pet owner to insert bits of food or paste into the interior of the chew toy. This rewards the dog for chewing, much as wild carnivores are rewarded for chewing on the bones of their prey.

While these types of pet chew toys are highly satisfying for the pet, they present significant issues of hygiene. Saliva and remnants of food in particular tend to adhere to the inner surface of the sidewall, making the chew toy hard to effectively clean by washing. Contaminants can also adhere to the rims of the openings that are defined in the sidewall. Over time, the pet chew toy may become infested with bacteria that creates odors and possibly poses health risks to both animals and people. When the pet chew toy becomes odiferous, it becomes less attractive for the dog and a source of annoyance to the pet owner.

A need exists for an improved system and method for cleaning pet chew toys that is more effective in removing caked on food bits, bacteria and other contaminants from both the inner sidewall of the pet chew toy and the rims of the openings that are defined in the pet chew toy.

### SUMMARY OF THE INVENTION

Accordingly, it is an object of the invention to provide an improved system and method for cleaning pet chew toys that is more effective in removing caked on food bits, bacteria and other contaminants from both the inner sidewall of the pet chew toy and the rims of the openings that are defined in the pet chew toy.

In order to achieve the above and other objects of the invention, a system for cleaning a pet chew toy of the type that has a sidewall having an inner surface defining a hollow interior and at least one opening defined in the sidewall communicating with the hollow interior according to a first aspect of the invention includes a first brush having a stem portion and a plurality of bristles, the stem portion and the bristles both being constructed and arranged so as to be able to fit through an opening in the sidewall of the pet chew toy, the bristles being further being dimensioned so as to facilitate scrubbing of the inner surface of the sidewall of the pet chew toy; a handle operatively connected to the stem portion of the first brush; and a second brush that is constructed and arranged so as to be able to fit through a second opening in the sidewall of the pet chew toy.

According to a second aspect of the invention, a system for cleaning a pet chew toy of the type that has a sidewall having an inner surface defining a hollow interior and at least one opening defined in the sidewall communicating with the hollow interior includes a first brush having a stem portion and a plurality of bristles, the stem portion and the bristles both being constructed and arranged so as to be able to fit through an opening in the sidewall of the pet chew toy, the bristles being further being dimensioned so as to facilitate scrubbing of the inner surface of the sidewall of the pet chew toy; a handle operatively connected to the stem portion of the first brush; and wherein the first brush comprises a first lobe portion for cleaning a first part of a pet chew toy, a second lobe portion for cleaning a second part of a pet chew toy and a third lobe portion for cleaning a third part of a pet chew toy.

A method of maintaining a pet chew toy in good hygienic condition according to a third aspect of the invention includes steps of providing a pet chew toy of the type that has a sidewall having an inner surface defining a hollow interior and at least one opening defined in the sidewall communicating with the hollow interior; providing a pet chew toy cleaning system that includes first brush having a stem portion, a scrubbing portion that is dimensioned so as to facilitate scrubbing of the inner surface of the sidewall of the pet chew toy and a handle that is connected to said stem portion; inserting the first brush through the opening that is defined in the sidewall of the pet chew toy so that the bristles are substantially adjacent to the inner surface of the sidewall; and scrubbing the inner surface of the sidewall with the first brush.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a perspective view depicting a pet chew toy cleaning system that is constructed according to a preferred embodiment of the invention;

FIG. 2 is a side elevational view depicting the system that is shown in FIG. 1;

FIG. 3 is a side elevational view depicting one component of the system that is illustrated in FIGS. 1 and 2;

FIG. 4 is a diagrammatical depiction of one step in a method that is performed according to the preferred embodiment of the invention; and

FIG. 5 is a diagrammatical depiction of another step in the method that is performed according to the preferred embodiment of the invention.

### DETAILED DESCRIPTION OF THE PREFERRED EMBODIMENT(S)

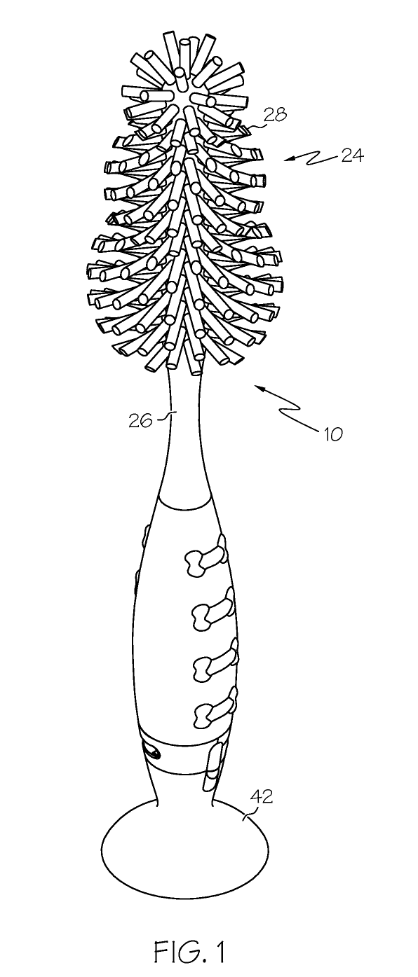

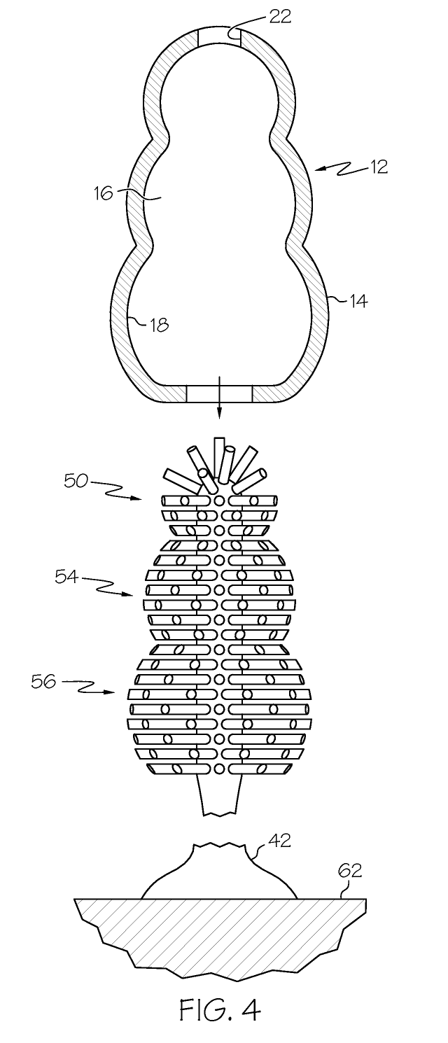

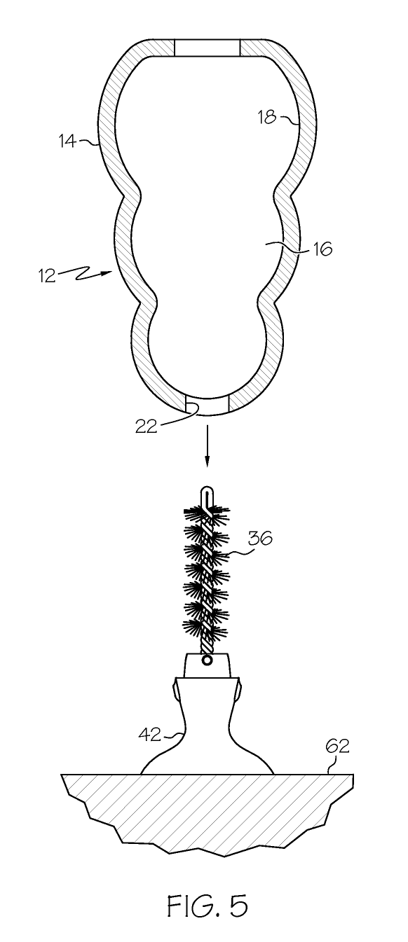

Referring now to the drawings, wherein like reference numerals designate corresponding structure throughout the views, and referring in particular to FIGS. 1, 4 and 5, a system 10 for cleaning a pet chew toy 12 according to a preferred embodiment of the invention is shown. Referring to FIG. 4, pet chew toy 12 has a sidewall 14 with an inner surface 18 that defines a hollow interior 16. A first opening in the sidewall 14 that is in communication with the hollow interior 16 is defined by a rim 20 at the bottom of the pet chew toy 12 as it is depicted in FIG. 4. A second opening in the sidewall 14 that is smaller than the first opening and that is also in communication with the hollow interior 16 is defined by a rim 22 at the top of the pet chew toy 12 as it is depicted in FIG. 4.

System 10 in the preferred embodiment includes a first brush 24 that has a stem portion 26 that extends along a longitudinal axis and that has a plurality of bristles 28. The stem portion 26 and the bristles 28 are preferably constructed and arranged so as to be able to fit through the first opening that is defined by the rim 20 in the sidewall 14 of the pet chew toy 12, as is diagrammatically shown in FIG. 4.

More specifically, the stem portion 26 has an outer diameter that is less than the inner diameter of the rim 20, and the bristles 28 are constructed with sufficient flexibility and have an orientation to facilitate the insertion and withdrawal of substantially all of the first brush 24 through the opening that is defined by the rim 20 and into and out of the hollow interior 16 of the pet chew toy 12.

In the preferred embodiment, those bristles 28 that would extend in length to have an outer diameter that is substantially greater than the inner diameter of the rim 20 defining the first opening in the pet chew toy 12 are oriented so as to be substantially horizontal or perpendicular to the longitudinal axis of the stem portion 26. One benefit of this orientation is that it optimizes the resistance of the bristles 28 as the first brush 24 is inserted and withdrawn from the pet chew toy 12. If the bristles 28 were angled upwardly, it would make it extremely difficult to insert the first brush 24 into the first opening that is defined by the rim 20. Conversely, if the bristles 28 were angled downwardly, it would make it extremely difficult to withdraw the first brush 24 from the first opening that is defined by the rim 20. The substantially horizontal orientation of the bristles 28 accordingly provides significant functional advantages during use of the system 10 to claim the pet chew toy 12.

In one embodiment of the invention that is designed for larger pet chew toys, those bristles 28 that would extend in length to have an outer diameter that is substantially greater than about 37 mm are oriented so as to be substantially horizontal or perpendicular to the longitudinal axis of the stem portion 26, while those bristles 28 that are located near the top of the first brush 24 and that have an outer diameter that is less than about 37 mm are angled upwardly to permit scrubbing of the underside of the inner surface of the portion of the sidewall 14 in which the rim 22 defining the second opening is located.

In another embodiment of the invention that is designed for smaller pet chew toys, those bristles 28 that would extend in length to have an outer diameter that is substantially greater than about 26 mm are oriented so as to be substantially horizontal or perpendicular to the longitudinal axis of the stem portion 26, while those bristles 28 that are located near the top of the first brush 24 and that have an outer diameter that is less than about 26 mm are angled upwardly to permit scrubbing of the underside of the inner surface of the portion of the sidewall 14 in which the rim 22 defining the second opening is located.

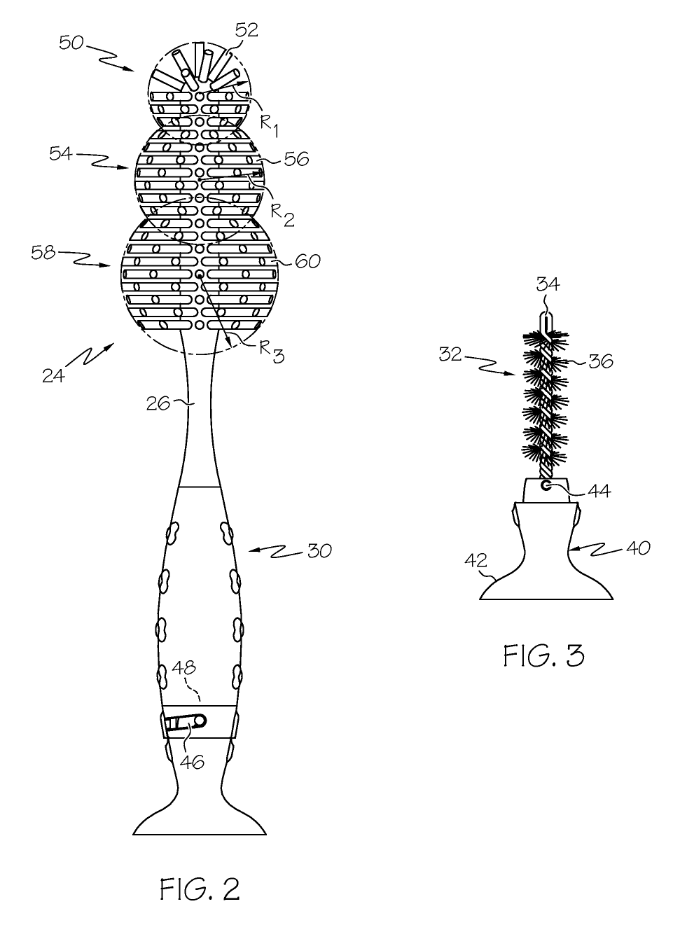

Referring now to FIG. 2, system 10 further includes a handle 30 that is operatively connected to the stem portion 26 of the first brush 24. According to one particularly advantageous feature of the preferred embodiment of the invention, a second brush 32 is provided for permitting scrubbing and cleaning of the second opening that is defined by the second rim 22 defined in the sidewall 14 of the pet chew toy 12. The second brush 32, which is best shown in FIG. 3, preferably includes a stem portion 34 that has an outer diameter that is less than the inner diameter of the rim 22 and a plurality of bristles 36.

In the preferred embodiment, bristles 36 are substantially constant length, giving the outer bristle profile of the second brush 32 a generally cylindrical shape. The bristles 36 are preferably oriented so as to be substantially horizontal or perpendicular to the longitudinal axis of the stem portion 34 in order to facilitate the insertion and withdrawal of the second brush 32 into and out of the second opening in the pet chew toy 12 defined by the second rim 22. As explained above in relation to the first brush 24, such a substantially horizontal orientation will optimize the resistance of the bristles 36 as the second brush 32 is inserted and withdrawn to and from the second opening.

Referring again to FIG. 3, second brush 32 in the preferred embodiment includes a base portion 40 having an integral elastomeric suction cup 42 that is designed to have a force of adhesion to a smooth horizontal surface that is sufficient to remain attached to the smooth horizontal surface when subjected to the forces that are likely to be generated by the relative movement between the first brush 24 and the pet chew toy 12 during scrubbing of the pet chew toy 12.

Second brush 32 also preferably includes a substantially horizontally extending cam follower element 44, while the lower portion of the handle 30 has a hollow receptacle 48 defined therein and a cam slot 46 defined in a sidewall of the handle 30 between the outer surface thereof and an inner wall that defines the hollow receptacle 48. The second brush 32 is releasably attachable to the handle 30 and the first brush 24 by inserting the upper portion of the second brush 32, including the stem 34 and the bristles 36, into the receptacle 48 and then twisting the suction cup 42 so as to cause the cam follower 44 to move to a locked position at the end of the cam slot 46.

Referring now to FIG. 2, another particularly advantageous feature of the preferred embodiment of the invention is that the first brush 24 includes a first plurality of bristles 52 that are arranged to form a first lobe portion 50, a second plurality of bristles 56 that are arranged to form a second lobe portion 54 and a third plurality of bristles 60 that define a third lobe portion 58.

The first lobe portion 50 is preferably characterized by the first plurality of bristles 52 having an outer extent that is spatially curved. More preferably, the outer extent that is defined by the first plurality of bristles 52 is substantially defined by a first substantially constant radius R₁ so as to give the outer extent the shape of a portion of a sphere. In one embodiment of the invention that is intended for larger pet chew toys, radius R₁ is preferably within a range of about 34 mm to about 40 mm and is most preferably about 37 mm. In a second embodiment of the invention that is intended for smaller pet chew toys, radius R₁ is preferably within a range of about 23 mm to about 29 mm, and is most preferably about 26 mm.

Alternatively, the first lobe portion 50 may be characterized by a first lobe that is fabricated from a foam, sponge or mesh material or a combination of such materials and bristles having an outer extent that is curved in the shape discussed above.

Likewise, the second lobe portion 54 is preferably characterized by the second plurality of bristles 56 having an outer extent that is spatially curved and that preferably substantially defines a second substantially constant radius R₂ that is greater than the first substantially constant radius R1 and that also takes the shape of a portion of a sphere. In the embodiment of the invention that is intended for larger pet chew toys, radius R₂ is preferably within a range about 44 mm to about 50 mm, and is most preferably about 47 mm. In the embodiment of the invention that is intended for smaller pet chew toys, radius R₂ is preferably within a range of about 32 mm to about 38 mm, and is most preferably about 35 mm.

Alternatively, the second lobe portion 54 may be characterized by a second lobe that is fabricated from foam, sponge or mesh material or a combination of such materials and bristles having an outer extent that is curved in the shape discussed above.

The third lobe portion 58 is preferably characterized by the third plurality of bristles 60 having an outer extent that is substantially spatially curved or shaped as a portion of a sphere having a substantially constant radius R₃ that is greater than either of the first or second radii R₁, R₂. In the embodiment of the invention that is intended for larger pet chew toys, radius R₃ is preferably within a range of about 54 mm to about 60 mm, and is most preferably about 57 mm. In the embodiment of the invention that is intended for smaller pet chew toys, radius R₃ is preferably within a range of about 42 mm to about 48 mm, and is most preferably about 45 mm.

Alternatively, the third lobe portion 58 may be characterized by a third lobe that is fabricated from a foam, sponge or mesh material or a combination of such materials and bristles having an outer extent that is curved in the shape discussed above.

In operation, the suction cup 42 may be secured to a smooth, preferably substantially horizontal surface 62, as is schematically shown in FIG. 4, so that the first brush 24 has its stem portion 26 oriented substantially vertically. The first brush 24 may be first wetted, and a cleaning agent such as soap or detergent may also be applied to the bristles of the first brush 24. The pet chew toy 12 may also first be wetted, and a cleaning agent such as soap or detergent may be applied thereto. As is shown schematically in FIG. 4, the lower end of the pet chew toy 12 having the rim 20 defining the first, larger opening may be lowered toward the upper end of the first brush 24, and the upper end of the first brush 24 may be inserted into the first opening that is defined by the rim 20.

As the pet chew toy 12 continues to be lowered on to the first brush 24, the bristles 52 of the first lobe 50 will deflect downwardly, permitting the first lobe 50 to enter the hollow interior 16 of the pet chew toy 12. The bristles 56 of the second lobe 54 will then deflect downwardly, permitting the second lobe 54 to enter the hollow interior 16. Finally, the bristles 60 of the third lobe 58 will deflect downwardly, permitting the third lobe 58 to enter the hollow interior 16.

At this point, the three lobes 50, 54, 58 will all be positioned within the hollow interior 16, and the outer extent of each of the lobes 50, 54, 58 will each be in contact with a corresponding portion of the inner surface 18 of the sidewall 14 of the pet chew toy 12. The user may then scrub the inner surface 18 through a combination of rotating the pet chew toy 12 around its longitudinal axis and moving it upwardly and downwardly, while the handle 30 and the stem portion 26 of the first brush 24 remained stationary relative to the support surface 62. For example, the support surface 62 may be the lower surface of a kitchen sink or utility tub. Because the adherence of the suction cup 42 to the support surface permits the interior of the pet chew toy 12 to be scrubbed using only one hand, the other hand may be available to hold a spray nozzle, apply soap or to perform other tasks.

Alternatively, the interior of the pet chew toy 12 may be scrubbed without the use of the suction cup 42 by holding the handle 30 in one hand while holding the pet chew toy 12 and the other hand.

After the interior surface 18 of the pet chew toy has been cleaned, the second brush 32 may be removed from the receptacle 48 that is provided within the handle 30 by twisting the suction cup 42 so that the cam follower 44 moves to the entrance of the cam slot 46 and then by pulling downwardly. The bristle portion 36 of the second brush 32 may then be inserted into the second hole that is defined by the upper rim 22 of the pet chew toy 12. Alternatively, the suction cup 42 may again be adhered to the smooth, preferably horizontal surface so that the rim 22 may be scrubbed using one hand only.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A system for cleaning a pet chew toy of the type that has a sidewall having an inner surface defining a hollow interior and at least one opening defined in the sidewall communicating with the hollow interior, comprising:
a first brush having a stem portion and a plurality of bristles, said stem portion and said bristles both being constructed and arranged so as to be able to fit through an opening in the sidewall of the pet chew toy, said bristles being further being dimensioned so as to facilitate scrubbing of the inner surface of the sidewall of the pet chew toy;
a handle operatively connected to said stem portion of said first brush; and
a second brush that is constructed and arranged so as to be able to fit through a second opening in the sidewall of the pet chew toy.

2. A system for cleaning a pet chew toy according to claim 1, wherein said second brush is removably mounted to said handle.

3. A system for cleaning a pet chew toy according to claim 2, wherein said second brush as a plurality of bristles and wherein a receptacle is defined within said handle, and wherein said plurality of bristles of said second brush are contained within said receptacle when said second brush is mounted to said handle.

4. A system for cleaning a pet chew toy according to claim 1, wherein at least one of said first and second brushes has a suction cup mounted thereto.

5. A system for cleaning a pet chew toy according to claim 1, wherein said first brush comprises a first plurality of bristles that are arranged to form a first lobe portion having a first outer curvature, a second plurality of bristles that are arranged to form a second lobe portion having a second outer curvature and a third plurality of bristles that are arranged to form a third lobe portion having a third outer curvature.

6. A system for cleaning a pet chew toy according to claim 5, wherein said first lobe portion is characterized by having an outer extent that is substantially defined by a first substantially constant radius, said second lobe portion is characterized by having an outer extent that is substantially defined by a second substantially constant radius that is larger than said first substantially constant radius, and wherein said third lobe portion is characterized by having an outer extent that is substantially defined by a third substantially constant radius, said third substantially constant radius being larger than both said first and second substantially constant radii.

7. A system for cleaning a pet chew toy according to claim 5, wherein said second lobe portion has a width that is greater than a width of said first lobe portion, and said third lobe portion has a width that is greater than the width of said second lobe portion.

8. A system for cleaning a pet chew toy according to claim 1, wherein said stem portion has a longitudinal axis, and wherein said bristles are oriented so as to be substantially perpendicular to said longitudinal axis.

9. A system for cleaning a pet chew toy of the type that has a sidewall having an inner surface defining a hollow interior and at least one opening defined in the sidewall communicating with the hollow interior, comprising:
a first brush having a stem portion and a plurality of bristles, said stem portion and said bristles both being constructed and arranged so as to be able to fit through an opening in the sidewall of the pet chew toy, said bristles being further being dimensioned so as to facilitate scrubbing of the inner surface of the sidewall of the pet chew toy;
a handle operatively connected to said stem portion of said first brush; and
wherein said first brush comprises a first lobe portion for cleaning a first part of a pet chew toy, a second lobe portion for cleaning a second part of a pet chew toy and a third lobe portion for cleaning a third part of a pet chew toy.

10. A system for cleaning a pet chew toy according to claim 9, wherein said first lobe portion is characterized by having an outer extent that is substantially defined by a first substantially constant radius, said second lobe portion is characterized by having an outer extent that is substantially defined by a second substantially constant radius that is larger than said first substantially constant radius, and wherein said third lobe portion is characterized by having an outer extent that is substantially defined by a third substantially constant radius, said third substantially constant radius being larger than both said first and second substantially constant radii.

11. A system for cleaning a pet chew toy according to claim 9, wherein said stem portion has a longitudinal axis, and wherein said bristles are oriented so as to be substantially perpendicular to said longitudinal axis.

12. A system for cleaning a pet chew toy according to claim 9, wherein said first lobe portion comprises a plurality of bristles.

13. A system for cleaning a pet chew toy according to claim 9, wherein said second lobe portion comprises a plurality of bristles.

14. A system for cleaning a pet chew toy according to claim 9, wherein said third lobe portion comprises a plurality of bristles.

15. A method of maintaining a pet chew toy in good hygienic condition, comprising steps of:
providing a pet chew toy of the type that has a sidewall having an inner surface defining a hollow interior and at least one opening defined in the sidewall communicating with the hollow interior;
providing a pet chew toy cleaning system that includes a first brush having a stem portion, a scrubbing portion that is dimensioned so as to facilitate scrubbing of the inner surface of the sidewall of the pet chew toy and a handle that is connected to said stem portion;
inserting the first brush through the opening that is defined in the sidewall of the pet chew toy so that said bristles are substantially adjacent to said inner surface of said sidewall; and
scrubbing said inner surface of said sidewall with said first brush.

16. A method of maintaining a pet chew toy in good hygienic condition according to claim 15, wherein said step of providing a pet chew toy cleaning system includes providing a first brush that comprises a first lobe portion for cleaning a first part of a pet chew toy, a second lobe portion for cleaning a second part of a pet chew toy and a third lobe portion for cleaning a third part of a pet chew toy and wherein said step of inserting the first brush through the opening is performed by first inserting said first lobe portion through said opening that is defined in the sidewall of the pet chew toy, then inserting the second lobe portion through said opening and finally inserting the third lobe portion through said opening.

17. A method of maintaining a pet chew toy in good hygienic condition according to claim 16, wherein said step of providing a pet chew toy cleaning system is performed by further providing a second brush, and wherein said method further comprises a step of cleaning a second opening in said sidewall of said pet chew toy using said second brush.

18. A method of maintaining a pet chew toy in good hygienic condition according to claim 17, wherein said step of providing a pet chew toy cleaning system is further performed by providing said second brush so that it is removably mounted to said handle, and wherein said method further comprises a step of removing said second brush from said handle prior to cleaning said second opening.

19. A method of maintaining a pet chew toy in good hygienic condition according to claim 15, further comprising a step of securing the first brush to an external surface prior to said step of scrubbing said inner surface of said sidewall with said first brush.

20. A method of maintaining a pet chew toy in good hygienic condition according to claim 19, wherein said pet chew toy cleaning system includes a suction cup that is operatively connected with said handle, and wherein said step of securing the first brush to an external surface is performed by adhering said suction cup to the external surface.

21. A method of maintaining a pet chew toy in good hygienic condition according to claim 15, wherein said stem portion of said first brush has a longitudinal axis, and further comprising a step of storing said first brush so that said longitudinal axis is substantially vertical after said step of scrubbing said inner surface of said sidewall with said brush.

22. A method of maintaining a pet chew toy in good hygienic condition according to claim 21, wherein said pet chew toy cleaning system includes a suction cup that is connected with said first brush, and wherein said step of storing said first brush so that said longitudinal axis is substantially vertical is performed by adhering said suction cup to an external surface.

23. A method of maintaining a pet chew toy in good hygienic condition according to claim 22, wherein said suction cup is removably mounted to said handle.

24. A method of maintaining a pet chew toy in good hygienic condition according to claim 18, wherein said second brush as a suction cup attached thereto, and further comprising a step of attaching said suction cup to an external surface prior to cleaning said second opening.

25. A method of maintaining a pet chew toy in good hygienic condition according to claim 16, wherein said first lobe portion comprises a first plurality of bristles.

26. A method of maintaining a pet chew toy in good hygienic condition according to claim 16, wherein said second lobe portion comprises a second plurality of bristles.

27. A method of maintaining a pet chew toy in good hygienic condition according to claim 16, wherein said third lobe portion comprises a third plurality of bristles.
